(19) United States
(12) Patent Application Publication
(10) Pub. No.: US 2021/0137310 A1
(43) Pub. Date: May 13, 2021

(54) ARTIFICIAL INTELLIGENCE COOKING DEVICE

(71) Applicant: LG ELECTRONCS INC., Seoul (KR)

(72) Inventor: Hyunseung SHIM, Seoul (KR)

(73) Assignee: LG ELECTRONICS INC., Seoul (KR)

(21) Appl. No.: 17/037,483

(22) Filed: Sep. 29, 2020

(30) Foreign Application Priority Data
Nov. 8, 2019 (KR) 10-2019-0142974

(51) Int. Cl. A47J 36/32; G06N 3/04; G06K 9/32

(52) U.S. Cl. CPC A47J 36/32; G06K 9/3241; G06N 3/04

(57) ABSTRACT

An artificial intelligence (AI) cooking device is provided. The AI cooking device includes a cooking utensils configured to perform cooking, one or more cameras configured to capture a food, an output interface, and at least one processor configured to obtain a cooking state by providing an image obtained by capturing the food to an artificial intelligence model, and control the output interface to output result data indicating the cooking state. The AI model includes a neural network trained by using a training food image and a training cooking state labeled to the training food image.

### CROSS-REFERENCE TO RELATED APPLICATIONS

Pursuant to 35 U.S.C. § 119(a), this application claims the benefit of earlier filing date and right of priority to Korean Patent Application No. 10-2019-0142974, filed on Nov. 8, 2019, the contents of which are all hereby incorporated by reference herein in its entirety.

### BACKGROUND

The present disclosure relates to an artificial intelligence cooking device capable of checking a cooking state by capturing a food image.

Artificial intelligence (AI) is one field of computer engineering and information technology for studying a method of enabling a computer to perform thinking, learning, and self-development that can be performed by human intelligence and may denote that a computer imitates an intelligent action of a human.

Also, AI is directly or indirectly associated with the other field of computer engineering without being individually provided. Particularly, at present, in various fields of information technology, an attempt to introduce AI components and use the AI components in solving a problem of a corresponding field is being actively done.

Meanwhile, techniques for perceiving and learning the surrounding situation by using AI and providing information desired by the user in a desired form, or performing an operation or function desired by the user are being actively studied.

An electronic device that provides such various operations and functions may be referred to as an AI device.

Meanwhile, if cooking using a cooking device such as an oven or a microwave oven, a user sets a temperature and a time using his or her experience or recipe.

However, cooking states (whether food is well cooked, only partially cooked, not cooked, etc.) may vary depending on various conditions such as a shape of a bowl, a position of a bowl, conditions of ingredients, an amount of ingredients, sizes of ingredients, and cooking ability.

A method of checking a current cooking state is an empirical method in which a user directly pulls out food, checks the food with his or her eyes, presses the food with his or her hands, or smells the food.

However, such a method is inaccurate, inconvenient, and in some cases, a user may be burned.

### SUMMARY

The present disclosure has been made in an effort to solve the above-described problems and provides an AI cooking device capable of checking a cooking state by capturing a food image.

In one embodiment, an AI cooking device includes a cooking utensils configured to perform cooking, one or more cameras configured to capture a food, an output interface, and at least one processor configured to obtain a cooking state by providing an image obtained by capturing the food to an artificial intelligence model, and control the output interface to output result data indicating the cooking state, wherein the AI model includes a neural network trained by using a training food image and a training cooking state labeled to the training food image.

The details of one or more embodiments are set forth in the accompanying drawings and the description below. Other features will be apparent from the description and drawings, and from the claims.

### BRIEF DESCRIPTION OF THE DRAWINGS

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIGS. 4 to 6 are views for describing an AI cooking device according to an embodiment of the present disclosure.

FIG. 7 is a view for describing an operating method of the AI cooking device according to an embodiment of the present disclosure.

FIG. 8 is a view for describing a method of performing cooking.

FIG. 9 is a view for describing a method of capturing an image of food and providing an AI model.

FIG. 10 is a view for describing a training method of an AI model.

FIG. 11 is a view for describing a cooking degree for each part.

FIG. 12 is a view for describing a method of displaying cooking or non-cooking for each part or a cooking degree for each part with a color.

FIG. 13 is a view for describing a plurality of AI models corresponding various types of foods.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driver including an actuator or a motor and may perform various physical operations such as moving a robot joint. In addition, a movable robot may include a wheel, a brake, a propeller, and the like in a driver, and may travel on the ground through the driver or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication interface 110, an input interface 120, a learning processor 130, a sensor 140, an output interface 150, a memory 170, and a processor 180.

The communication interface 110 may transmit and receive data to and from external devices such as other AI devices 100a to 100e and the AI server 200 by using wire/wireless communication technology. For example, the communication interface 110 may transmit and receive sensor information, a user input, a learning model, and a control signal to and from external devices.

The communication technology used by the communication interface 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a learning data for model learning and an input data to be used when an output is acquired by using learning model. The input interface 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensor 140 may acquire at least one of internal information about the AI device 100, ambient environment information about the AI device 100, and user information by using various sensors.

Examples of the sensors included in the sensor 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

At this time, the output interface 150 may include a display for outputting time information, a speaker for outputting auditory information, and a haptic module for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI device 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication interface 210, a memory 230, a learning processor 240, a processor 260, and the like.

The communication interface 210 can transmit and receive data to and from an external device such as the AI device 100.

The memory 230 may include a model storage 231. The model storage 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external device to determine the travel route and the travel plan, and may control the driver such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driver based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external device to determine the travel route and the travel plan, and may control the driver such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driver based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driver of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

FIGS. 4 to 6 are views for describing an AI cooking device according to an embodiment of the present disclosure.

Hereinafter, an AI cooking device will be described as an example of an oven.

In general, an oven is an appliance that heats and cooks food disposed in a predetermined space. The oven may be classified into an electric oven, an gas oven, a microwave oven, etc. according to a heat source. For example, the electric oven uses an electric heater as a heat source, the gas oven uses heat caused by gas as a heat source, and the microwave oven use frictional heat of water molecules caused by high frequency as a heat source.

FIG. 4 is a view illustrating an oven according to an embodiment of the present disclosure, and FIG. 5 is a view illustrating a door opening of the oven according to an embodiment of the present disclosure.

As illustrated in FIGS. 4 and 5, the oven 1 according to the present disclosure includes a case 10 forming an appearance and a door 20 attached to one surface of the case 10.

The case 10 is provided in a shape having an internal space, and a front side of the case 10 is opened. The case 10 may be formed in a predetermined box shape, and a power supply 14, an input interface 15, and a display 16 provided to a user are provided outside the case 10.

The power supply 14 is provided in various shapes that enables the user to turn on/off power of the oven 1. In addition, the input interface 15 is provided with a plurality of buttons that enables the user to select various modes, temperatures, and times.

The display 16 may be understood as a configuration that visualizes predetermined information such that the user can determine the state of the oven 1. In particular, the display 16 may be turned on/off together with the power supply 14 and may be provided in a predetermined panel form. The display 16 will be described below in detail.

A cooking chamber 11 in which food is accommodated is formed inside the case 10. The cooking chamber 11 may be provided with a grill 12 on which food is placed. In addition, a grill mounting portion 13 may be provided on the inner wall of the cooking chamber 11 such that the grill 12 is detachably installed. The grill 12 and the grill mounting portion 13 may be provided in various numbers and shapes.

In addition, a heater 17, a fan 18, and a fan motor 19 for providing driving force to the fan 18 are disposed inside the case 10 and outside the cooking chamber 11. The heater 17 heats the inside of the cooking chamber 11, and the fan 18 allows air to flow inside the cooking chamber 11.

The heater 17 may be provided as an electric heater for radiating heat by the input of electricity and may be installed at one side of the case 10. In addition, the heater 17 may be installed at one side of the fan 18 and may be integrally formed with the fan 18. The fan 18 receives the driving force from the fan motor 19 to allow the air heated by the heater 17 to flow inside the cooking chamber 11.

That is, the heater 17 and the fan 18 are understood as a configuration for cooking food in the cooking chamber 11. The shapes shown in the drawings are merely an example and may be variously provided. In addition, the oven 1 according to the present disclosure is not limited to the electric oven using electricity as the heat source, and may cook food using various heat sources such as the gas oven or the microwave oven.

The door 20 is disposed on the opened front surface of the case 10 to open or close the cooking chamber 11. That is, the cooking chamber 11 may be opened or closed by the door 20. For convenience of description, configurations related to an installation structure and a locking device of the door 20 is omitted in the drawings.

As illustrated in FIG. 5, the door 20 is rotatably installed forward on the front surface of the case 10. In addition, the door 20 may be provided with a handle 21 that the user can grip and rotate.

In addition, the oven 1 according to the present disclosure may be provided with a predetermined detector configured to detect the internal state of the cooking chamber 11. The detector may include a camera 32 configured to capture an image of the inside of the cooking chamber 11. The camera 32 may be disposed at one side of the cooking chamber 11 to provide an image of the inside of the cooking chamber 11.

FIG. 6 is a view illustrating the control configuration of the oven according to an embodiment of the present disclosure.

The oven 1 according to the present disclosure is provided with a processor 50 configured to control the above-described configuration.

The user may transmit a predetermined command to the processor 50 by using the power supply 14 and the input interface 15. In this case, as described above, the power supply 14 and the input interface 15 may be provided outside the case 10 or may be provided in the mobile device 60 of the user.

For example, the processor 50 and the mobile device 60 may be connected via Bluetooth or the like to exchange predetermined information. That is, the user may input a command to control the oven 1 at a long distance. For example, the user may preheat the oven 1 using the mobile device 60, and after the preheating is completed, the user may approach the oven 1 and input food to the oven 1.

In addition, the processor 50 may receive information detected by a predetermined detector. The detector may include the above-described camera 32 and a temperature sensor 30 configured to measure the temperature inside the cooking chamber 11. In detail, the camera 32 may transmit, to the processor 50, an image generated by capturing an image of the inside of the cooking chamber 11. The temperature sensor 30 may transmit temperature information inside the cooking chamber 11 to the processor 50.

In addition, the processor 50 may be provided with a timer 52 configured to measure a predetermined time. For example, if the cooking is started, the processor 50 may transmit a command to the timer 52 to measure a cooking time, or may turn on the power of the oven 1 in accordance with a reservation time.

The processor 50 may operate the heater 17 and may supply power to the fan motor 19 to drive the fan 18.

In addition, the processor 50 may transmit predetermined information to the display or the mobile device 60 for visualization. For example, the temperature transmitted by the temperature sensor 30 and the cooking time measured by the timer 52 may be visualized.

The display includes the case display 16 and the door display 40 described above. The processor 50 may visualize information about at least one of the case display 16, the door display 40, or the mobile device 60.

Meanwhile, the AI cooking device may include all or part of the configurations of the AI device 100 described with reference to FIG. 1 and may perform the functions performed by the AI device 100.

In addition, the AI cooking device may include all or part of the configurations of the oven described with reference to FIGS. 4 to 6 and may perform the functions performed by the oven.

Meanwhile, the AI cooking device has been described as an example of the oven, but the present disclosure is not limited thereto.

For example, the AI cooking device described in the present disclosure may be applied to all products including the cooking utensils for performing cooking, such as a gas stove, an electric stove, a microwave oven, an induction, a hybrid, and a highlight.

FIG. 7 is a view for describing an operating method of the AI cooking device according to an embodiment of the present disclosure.

The operating method of the AI cooking device according to an embodiment of the present disclosure may include: performing cooking (S710); capturing an image of the cooking (S720); obtaining a cooking state by providing the image of the cooking to an AI model (S730); outputting result data indicating the cooking state (S740); and stopping cooking if a result value indicating the completion of the cooking is output by the AI model (S750).

FIG. 8 is a view for describing a method for performing cooking.

The AI cooking device may include one or more cooking utensils (not shown) that performs cooking.

If the AI cooking device is the oven 1, the cooking utensils (not shown) may include the heater 17, the fan 18, and the fan motor 19. In addition, the cooking utensils (not illustrated) may include a fan and a fan motor capable of generating heat convection or adjusting an air circulation direction.

If the AI cooking device is the microwave oven, the microwave oven may include a cabinet with a door, a cavity installed at one side of the cabinet to accommodate an object to be cooked, a flat table which is installed on the inner bottom of the cavity and on which the object to be cooked is capable of being placed, a magnetron installed at the other side of the cabinet to generate an electromagnetic wave capable of heating the object to be cooked, a waveguide configured to connect the magnetron and the cavity, a driving motor configured to rotate the flat table, a fan and a fan motor capable of generating heat convection or adjusting an air circulation direction, and a controller configured to control the operation of the microwave oven.

If the microwave oven is operated, the electromagnetic wave is generated from the magnetron. The electromagnetic wave is radiated to the cavity through the waveguide and a stirrer and penetrate into the object to be cooked on the flat table. Due to the electromagnetic wave, molecular motion of the object to be cooked is activated and heat is generated in the object to be cooked, thereby achieving the cooking.

Meanwhile, if the AI cooking device is the microwave oven, the cooking utensils may include a cavity, a magnetron, a waveguide, a stirrer, a flat table, a driving motor, and a fan and a fan motor capable of generating heat convection or controlling an air circulation direction.

Meanwhile, the processor may control the cooking utensils to perform cooking. As the cooking is performed, food placed inside the AI cooking device (or on the AI cooking device) may be cooked.

FIG. 9 is a view for describing a method of capturing an image of food and providing an AI model.

Referring to FIG. 9, the processor may capture a food via the camera.

In detail, the processor may capture a food inside the AI cooking device (or on the AI cooking device) while the AI cooking device performs the cooking operation. In addition, after the AI cooking device completes the cooking operation, the processor may capture a food inside the AI cooking device (or on the AI cooking device).

Meanwhile, the camera may be disposed to capture the inside of the cooking chamber, but the present disclosure is not limited thereto.

For example, the camera may be disposed to capture an image of the front of the AI cooking device. In this case, the user may place food in front of the camera and request a capturing of an image, and the processor may output result data indicating a cooking state by using an image obtained by capturing the food.

Meanwhile, the processor may capture a food at a predetermined period while the AI cooking device performs the cooking operation.

However, the present disclosure is not limited thereto, and when a cooking state checking request is received from the user via the input interface, the processor may capture a food. For example, if a user receives a voice input of “please check how well food is cooked”, the processor may capture a food and provide an image obtained by capturing the food to the AI model.

Meanwhile, the processor may provide the image 910 obtained by capturing the food to the AI model 920. In detail, the processor may provide the image 910 obtained by capturing the food to the AI model 920 as input data of the AI model 920.

FIG. 10 is a view for describing a training method of an AI model.

A method of generating the AI model 920 will be described.

The AI model 920 may be a neural network trained by using a training food image and a training cooking state labeled to the training food image.

The training cooking state may include the completion or non-completion of cooking, the degree of completion of cooking, the cooking or non-cooking of food for each part, or the cooking degree of food for each part.

A method of training a neural network 1020 so as to predict the completion or non-completion of cooking will be described with reference to FIG. 10A.

The AI model 920 may be a neural network 1020 trained by using training image data including food and labeling data including the completion or non-completion of cooking.

The completion or non-completion of cooking may include information indicating that cooking is completed and information indicating that cooking is not completed. That the cooking is completed may mean that all parts of the food are cooked, and that the cooking is not completed may mean that all or part of the food are less cooked.

The learning apparatus 200 may train the neural network 1020 by labeling information about the completion or non-completion of cooking to the training food image 1010.

In detail, the learning apparatus 200 may train the neural network by using the training food image (including food as an image collected for training) as an input and the completion or non-completion of cooking with respect to food included in the training food image as an output. The completion or non-completion of cooking (whether cooking is completed or whether cooling is not completed) may be a correct answer that the neural network should infer using the training food image.

For example, the learning apparatus 200 may train the neural network 1020 by labeling information indicating that cooking is completed to the image of the completely cooked food (e.g., a chicken whose all parts are cooked).

In another example, the learning apparatus 200 may train the neural network 1020 by labeling information indicating that cooking is not completed to the image of the food whose cooking is not completed (e.g., a chicken whose 80% of all parts are cooked, or a chicken whose only some parts are not cooked).

In this case, the neural network 1020 may infer a function about a correlation about the training food image and the completion or non-completion of cooking by using the training food image and the information about the completion or non-completion of cooking (information indicating that the cooling is completed or information indicating that the cooking is not completed). In addition, parameters (weight, bias, etc.) of the neural network may be determined (optimized) through the evaluation of the function inferred in the neural network

A method of training a neural network 1030 so as to predict the degree of completion of cooking will be described with reference to FIG. 10B.

The AI model 920 may be a neural network 1030 trained by using training image data including food and labeling data including the degree of completion of cooking.

The degree of completion of cooking may include information about how well the food is cooked.

The learning apparatus 200 may train the neural network 1030 by labeling information about the degree of completion of cooking to the training food image 1010.

In detail, the learning apparatus 200 may train the neural network by using the training food image (including food as an image collected for training) as an input and the degree of completion of cooking with respect to the food included in the training food image as an output. The degree of completion of cooking (how much the cooking is completed) may be a correct answer that the neural network should infer using the training food image.

For example, the learning apparatus 200 may train the neural network 1030 by labeling information indicating that cooking is 100% completed to the image of the completely cooked food (e.g., a chicken whose all parts are cooked).

In another example, the learning apparatus 200 may train the neural network 1030 by labeling information indicating that cooking is 70% completed to the image of the food whose cooking is 70% completed (e.g., a chicken whose 70% of all parts are cooked, or a chicken whose 70% of parts are well cooked and 30% of parts are not well cooked).

In this case, the neural network 1030 may infer a function about a correlation about the training food image and the degree of completion of cooking by using the training food image and the degree of completion of cooking. In addition, parameters (weight, bias, etc.) of the neural network may be determined (optimized) through the evaluation of the function inferred in the neural network.

A method of training a neural network 1040 so as to predict the cooking or non-cooking of food for each part will be described with reference to FIG. 10C.

The AI model 920 may be a neural network 1040 trained by using training image data including food and labeling data including the cooking or non-cooking of food for each part.

The cooking or non-cooking of food for each part may include information about a well cooked region and a not-well cooked region.

The learning apparatus 200 may train the neural network 1040 by labeling information the cooking or non-cooking of food for each part to the training food image 1010.

In detail, the learning apparatus 200 may train the neural network by using the training food image (including food as an image collected for training) as an input and the cooking or non-cooking of food for each part with respect to food included in the training food image as an output. The cooking or non-cooking of food for each part (the well cooked region and the non-well cooked region) may be a correct answer that the neural network should infer using the training food image.

For example, the learning apparatus 200 may train the neural network 1040 by labeling at least one of the well cooked region or the not-well cooked region to the food image (e.g., a chicken whose chest is not cooked and parts other than the chest are cooked).

In this case, the neural network 1040 may infer a function about a correlation about the training food image and the cooking or non-cooking of food for each part by using the training food image and the cooking or non-cooking of food for each part. In addition, parameters (weight, bias, etc.) of the neural network may be determined (optimized) through the evaluation of the function inferred in the neural network.

A method of training a neural network 1050 so as to predict a cooking degree of food for each part will be described with reference to FIGS. 10D and 11.

FIG. 11 is a view for describing a cooking degree for each portion.

The AI model 920 may be a neural network 1050 trained by using training image data including food and labeling data including the cooking degree of food for each part.

The cooking degree of food for each part may include information about how well the food is cooked. For example, the cooking degree of food for each part may include information about a first region that is cooked by a first value, information about a second region that is cooked by a second value, and information about a third region that is cooked by a third value.

The learning apparatus 200 may train the neural network 1050 by labeling the cooking degree of food for each part to the training food image 1010.

In detail, the learning apparatus 200 may train the neural network by using the training food image (including food as an image collected for training) as an input and the cooking degree of food for each part with respect to food included in the training food image as an output. The cooking degree of food for each part may be a correct answer that the neural network should infer using the training food image.

For example, the learning apparatus 200 may train the neural network 1050 by labeling a 60% cooked region, a 80% cooked region, a 90% cooked region, and a 100% cooked region to the food image (e.g., a chicken whose chest part is 60% cooked, thigh part is 60% cooked, leg part is 90% cooked, and the other parts are well cooked).

As another example, as illustrated in FIG. 11, the learning apparatus 200 may train the neural network 1050 by labeling a 100% cooked region 1121, a 90% cooked region 1122, a 60% cooked region 1123, and a 50% cooked region 1124 to a food image 1110 including a bread.

In this case, the neural network 1050 may infer a function about a correlation about the training food image and the cooking degree of food for each part by using the training food image and the cooking degree of food for each part. In addition, parameters (weight, bias, etc.) of the neural network may be determined (optimized) through the evaluation of the function inferred in the neural network.

Meanwhile, the learning apparatus 200 may train the neural network by using various training images and the completion or non-completion of cooking labeled to the various training images.

In detail, the learning apparatus 200 may train the neural network by using images having varying cooking degree, images having cooking degrees for various parts, images captured at various angles, images captured at various illuminations, images captured at various distances, images obtained by capturing foods of various sizes (e.g., a large chicken, a small chicken, etc.).

Meanwhile, the neural network trained in the above manner may be referred to as an AI model.

Meanwhile, the AI model may be mounted on the AI cooking device.

In detail, the AI model may be implemented by hardware, software, or a combination of hardware and software. If all or part of the AI model is implemented by software, one or more instructions constituting the AI model may be stored in the memory 170 of the AI cooking device.

Meanwhile, the processor 180 may obtain the cooking state by providing the image of the food to the AI model.

In detail, the processor 180 may input the image of the food to the AI model 920.

In this case, the AI model 920 may extract a feature vector including at least one of a color of a food surface, a texture of a food surface, and a shape of a food from the image of the food.

The feature vector may be an element indicating whether the food is cooked.

For example, a bread whose surface color is brown may indicate that the bread is well cooked, and a bread whose surface color is white may indicate that the bread is not well cooked.

In another example, a chicken whose surface is smooth may indicate that the chicken is not well cooked, and a chicken whose surface is rough may indicate that the chicken is well cooked.

In another example, a bread whose shape swells may indicate that the bread is well cooked, and a bread whose shape does not swell may indicate that the bread is less well cooked.

The AI model 920 may output the cooking state corresponding to the captured image by using the extracted feature vector.

The cooking state may include the completion or non-completion of cooking, the degree of completion of cooking, the cooking or non-cooking of food for each part, or the cooking degree of the food for each part.

For example, if the AI model 920 is the neural network 1020 trained by using training image data including food and labeling data including the completion or non-completion of cooking, the AI model 920 may extract a feature vector from a captured image and output, based on the extracted feature vector, information indicating that cooking is completed (information indicating that all parts of the food are well cooked) or information indicating that cooking is not completed (information indicating that all or part of the food are less cooked).

In another example, if the AI model 920 is the neural network 1030 trained by using training image data including food and labeling data including the degree of completion of cooking, the AI model 920 may extract a feature vector from a captured image and output, based on the extracted feature vector, how much the cooking is completed (e.g., 90% completed).

In another example, if the AI model 920 is the neural network 1040 trained by using training image data including food and labeling data including the cooking or non-cooking of food for each part, the AI model 920 may extract a feature vector from a captured image and output, based on the extracted feature vector, information about a well cooked region and information about a not-well cooked region.

In another example, if the AI model 920 is the neural network 1050 trained by using training image data including food and labeling data including the cooking degree of food for each part, the AI model 920 may extract a feature vector from a captured image and output, based on the extracted feature vector, information about a region cooked by a first value (100%), information about a region cooked by a second value (80%), information about a region cooked by a third value (70%), and information about a region cooked by a fourth value (50%).

Meanwhile, the processor may control the output interface to output result data indicating the cooking state.

In detail, the processor may control the speaker to output, as voice, the result data indicating the cooking state.

For example, the processor may output a voice message such as “cooking is complete (or food is well cooked)” or “cooking is not completed (or food is not well cooked).”

In another example, the processor may output a voice message such as “cooking is 70% complete (or food is 70% cooked)” or “cooking is all completed (or food is 100% cooked).”

In another example, the processor may output a voice message such as “a chicken leg is not cooked,” “a chicken's right part is not cooked,” or “all parts are well cooked.”

In another example, the processor may output a voice message such as “a chicken's leg part is 100% cooked, a chicken's wing part is 80% cooked, the other parts are 60% cooked, a chicken's right part is 80% cooked, a chicken's upper part is 100% cooked, and a chicken's left part is 90% cooked,” or “all parts of a bread are well cooked.”

In addition, the processor may control the display to output, as an image, the result data indicating the cooking state.

For example, the processor may display a user interface (UI) element indicating that cooking is completed or a UI element indicating that cooking is not completed.

In another example, the processor may display a UI element indicating the degree of completion of cooking.

In addition, the processor may display a UI element indicating the cooking or non-cooking of food for each part or a UI element indicating the cooking degree for each part.

This will be described below with reference to FIG. 12.

FIG. 12 is a view for describing a method of displaying cooking or non-cooking for each part or the cooking degree for each part with a color.

Referring to FIG. 12, the processor may display an image indicating food.

The image indicating the food may be an image of food. In detail, the image indicating the food may be an image of food, which is input data used by the AI model so as to output a cooking state.

In addition, the image indicating the food may be an image including an object having a shape corresponding to the image obtained by capturing the food. For example, if the image obtained by capturing the food is a round bread, the image indicating the food may be an image including a round object.

Meanwhile, the processor may display, as the result data, an “image indicating food, whose cooking or non-cooking for each part is displayed with a color.”

In detail, referring to FIG. 12A, the processor may display an image indicating food, in which a well cooked region 1210 is displayed with a first color and a not-well cooked region 1220 is displayed with a second color.

For example, if the image indicating the food is an image of food, the processor may display a well cooked region on the food with a red color and a not-well cooked region on the food with a yellow color.

In another example, if the image indicating the food is an image including an object having a shape corresponding to the image obtained by capturing the food, the processor may display a well cooked region on the object with a red color and a not-well cooked region on the object with a yellow color.

Meanwhile, the processor may display, as the result data, an “image indicating the food, whose cooking degree for each part is displayed with a color.”

In detail, referring to FIG. 12B, the processor may display an image indicating food, in which a region 1230 cooked by a first value is displayed with a first color, a region 1240 cooked by a second value is displayed with a second color, and a region 1250 cooked by a third value is displayed with a second color.

For example, the processor may display a 100% cooked region with a red color, a 80% cooked region with a yellow color, and a 50% cooked region with a blue color.

Meanwhile, if a result value indicating the completion of cooking is output by the AI model, the processor may control the cooking utensils to stop cooking.

In detail, if the AI model 920 is the neural network 1020 trained by using training image data including food and labeling data including the completion or non-completion of cooking and the AI model 920 outputs information indicating the completion of cooking, the processor may control the heater to stop heating.

In addition, if the AI model 920 is the neural network 1030 trained by using training image data including food and labeling data including the degree of completion of cooking and the AI model 920 outputs information indicating 100% completion of cooking, the processor may control the heater to stop heating.

In addition, if the AI model 920 is the neural network 1040 trained by using training image data including food and labeling data including the cooking or non-cooking of food for each part and the AI model 920 outputs information indicating that all parts are well cooked, the processor may control the heater to stop heating.

In addition, if the AI model 920 is the neural network 1050 trained by using training image data including food and labeling data including the cooking degree of food for each part and the AI model 920 outputs information indicating that all parts are 100% cooked, the processor may control the heater to stop heating.

Meanwhile, the processor may control the cooking utensils to apply more heat to a less cooked region than a more cooked region based on the cooking or non-cooking for each part or the cooking degree for each part.

In detail, the processor may control the cooking utensils to apply more heat to a not-completely cooked region than a completely cooked region. In addition, the processor may control the cooking utensils to apply more heat a region with a low cooking degree (e.g., a region with a cooking degree of 50%) as compared to a region with a high cooking degree (e.g., a region with a cooking degree of 90%).

Meanwhile, if the AI cooking device is an oven, the processor may control the cooking utensils to apply more heat to a less cooked region than a more cooked region by controlling heat convection or an air circulation direction.

In addition, if the AI cooking device is a toaster, the processor may control the cooking utensils to apply more heat to a less cooked region than a more cooked region by partially controlling a heating wire.

Meanwhile, the processor may control the cooking utensils to apply uniform heat to a more cooked region than a less cooked region based on the cooking or non-cooking for each part or the cooking degree for each part.

For example, if a first region is 50% cooked and a second region is 30% cooked, it means that heat is not uniformly applied at present. If there is a difference in the cooking degree between regions or a difference in the cooking or non-cooking between regions, the processor may control the cooking utensils to apply the same heat to a more cooked region and a less cooked region.

For example, if the AI cooking device is a microwave oven, the processor may change the rotation speed of the flat table such that uniform heat is applied to a more cooked region and a less cooked region.

FIG. 13 is a view for describing a plurality of AI models corresponding various types of foods.

The AI model 920 may include a first AI model 1321 corresponding to a first type of food 1311, a second AI model 1322 corresponding to a second type of food 1312, a third AI model 1323 corresponding to a third type of food 1313, and a fourth AI model 1324 corresponding to a fourth type of food 1314.

The first AI model 1321 may be a neural network trained by using a training food image for the first type of food and a training cooking state labeled to the training food image.

For example, the first AI model 1321 may be a neural network trained by using a training food image for a bread and a training cooking state labeled to the training food image.

In addition, the second AI model 1322 may be a neural network trained by using a training food image for the second type of food and a training cooking state labeled to the training food image.

For example, the second AI model 1322 may be a neural network trained by using a training food image for a pizza and a training cooking state labeled to the training food image.

If the food is captured, the processor may determine the type of the food and provide the food image to an AI model corresponding to the determined type.

In detail, if the food is captured, the processor may determine the type of the food by using the image obtained by capturing the food. For example, if the food is captured, the processor may determine that the image obtained by capturing the food is a bread by object recognition of the image obtained by capturing the food.

When the type of the food is the first type, the processor may provide the image obtained by capturing the food to the first AI model. For example, if the image obtained by capturing the food is a bread, the processor may provide the image obtained by capturing the bread to the first AI model corresponding to the bread.

In this case, the processor may obtain the cooking state by providing the image obtained by capturing the food to the first AI model and control the output interface to output result data indicating the cooking state.

According to the present disclosure, the cooking state can be grasped by simply capturing an image without using the empirical method so as to check the cooking state. Therefore, according to the present disclosure, it is possible to solve the inconvenience of the user and more accurately grasp the cooking state.

In addition, according to the present disclosure, the completeness of cooking can be improved by displaying the cooking state for each region. For example, if the user is informed of where the less cooked region is, the user may take steps to cook the less cooked region intensively.

In addition, according to the present disclosure, it is possible to intuitively transmit the cooking state for each region to the user by providing the cooking state for each region with different colors.

In addition, according to the present disclosure, it is possible to prevent overcooking low and complete the best cooking by stopping the cooking automatically if all the regions are well cooked.

In addition, according to the present disclosure, the completeness of cooking may be improved by performing a control such that a less cooked region is intensively cooked or a more cooked region and a less cooked region are uniformly cooked.

According to the present disclosure, the cooking state can be grasped by simply capturing an image without using the empirical method so as to check the cooking state. Therefore, according to the present disclosure, it is possible to solve the inconvenience of the user and more accurately grasp the cooking state.

The above-described present disclosure may be implemented as a computer-readable code on a computer-readable medium in which a program is stored. The computer readable recording medium includes all types of recording devices in which data readable by a computer system is stored. Examples of the computer-readable recording medium include hard disk drives (HDD), solid state disks (SSD), silicon disk drives (SDD), read only memories (ROMs), random access memories (RAMs), compact disc read only memories (CD-ROMs), magnetic tapes, floppy discs, and optical data storage devices. Also, the computer may include a processor 180 of the terminal.

Therefore, the detailed description is intended to be illustrative, but not limiting in all aspects. It is intended that the scope of the present disclosure should be determined by the rational interpretation of the claims as set forth, and the modifications and variations of the present disclosure come within the scope of the appended claims and their equivalents.

What is claimed is:

1. An artificial intelligence cooking device comprising:
a cooking utensil configured to perform cooking of an object;
one or more cameras configured to capture an image of the object located in the cooking utensil;
an interface; and
at least one processor configured to:
obtain a cooking state of the object by inputting the captured image into an artificial intelligence model; and
control the interface to output result data indicating the obtained cooking state,
wherein the artificial intelligence model includes a neural network trained by using a training food image and a training cooking state labeled to the training food image.

2. The artificial intelligence cooking device of claim 1, wherein the cooking state includes a completion or a non-completion of cooking, a degree of progress toward the completion of cooking, information indicating whether a part of the object is cooked or not cooked, or information indicating how well a part of the object is cooked.

3. The artificial intelligence cooking device of claim 2, wherein the artificial intelligence model further includes a neural network trained by using training image data and corresponding labeling data including the completion or the non-completion of cooking.

4. The artificial intelligence cooking device of claim 2, wherein the artificial intelligence model further includes a neural network trained by using training image data and corresponding labeling data including the degree of progress toward the completion of cooking.

5. The artificial intelligence cooking device of claim 2, wherein the artificial intelligence model further includes a neural network trained by using training image data and corresponding labeling data including the information indicating whether a part of the object is cooked or not cooked.

6. The artificial intelligence cooking device of claim 2, wherein the artificial intelligence model further includes a neural network trained by using training image data and corresponding labeling data including the information indicating how well a part of the object is cooked.

7. The artificial intelligence cooking device of claim 2, wherein the at least one processor is configured to cause a display, as the outputted result data, of an output image associated with the object, wherein the output image includes colors that are displayed for showing: the completion of cooking or the non-completion of cooking for each part of the object or how well each part of the object is cooked.

8. The artificial intelligence cooking device of claim 1, wherein the artificial intelligence model is further configured to extract a feature vector indicating at least one of a color of an object surface, a texture of the object surface, or a shape of the object from the captured image, wherein the obtained cooking state is based at least in part on the extracted feature vector.

9. The artificial intelligence cooking device of claim 1, wherein the at least one processor is further configured to control the cooking utensil to stop performing cooking when a result value indicating a completion of cooking is output by the artificial intelligence model.

10. The artificial intelligence cooking device of claim 2, wherein the at least one processor is further configured to control the cooking utensil to apply more heat to a less cooked region based at least in part on the cooking state.

11. The artificial intelligence cooking device of claim 2, wherein the at least one processor is further configured to control the cooking utensil to apply a same heat to both a more cooked region and a less cooked region based at least in part on the cooking state.

12. The artificial intelligence cooking device of claim 1, wherein the artificial intelligence model further includes a first artificial intelligence model corresponding to a first type of object and a second artificial intelligence model corresponding to a second type of object, and
wherein the at least one processor is further configured to:
determine a type of object based at least in part on the captured image; and
provide the captured image to the first artificial intelligence model when the type of the object is determined to correspond to the first object.

13. An artificial intelligence cooking method comprising:
capturing an image of an object;
obtaining a cooking state of the object by inputting the captured image into an artificial intelligence model; and
outputting result data indicating the obtained cooking state, wherein the artificial intelligence model includes a neural network trained by using a training object image and a corresponding training cooking state labeled for the training object image.

14. The artificial intelligence cooking method of claim 13, wherein the cooking state includes a completion or a non-completion of cooking, a degree of progress toward the completion of cooking, information indicating whether a part of the object is cooked or not cooked, or information indicating how well a part of the object is cooked.

15. The artificial intelligence cooking method of claim 14, wherein the artificial intelligence model further includes a neural network trained by using training image data and corresponding labeling data including the completion or the non-completion of cooking.

16. The artificial intelligence cooking method of claim 14, wherein the artificial intelligence model further includes a neural network trained by using training image data and corresponding labeling data including the degree of progress toward the completion of cooking.

17. The artificial intelligence cooking method of claim 14, wherein the artificial intelligence model further includes a neural network trained by using training image data and corresponding labeling data including the information indicating whether a part of the object is cooked or not cooked.

18. The artificial intelligence cooking method of claim 14, wherein the artificial intelligence model further includes a neural network trained by using training image data and corresponding labeling data including the information indicating well the part of the object is cooked.

19. The artificial intelligence cooking method of claim 14, wherein the outputting the result data further comprises displaying, as the outputted result data, an output image associated with the object, wherein the output image includes colors that are displayed for showing: the completion of cooking or the non-completion of cooking for each part of the object or how well each part of the object is cooked.

20. The artificial intelligence cooking method of claim 13, wherein the artificial intelligence model is further configured to extract a feature vector indicating at least one of a color of an object surface, a texture of the object surface or a shape of the object from the captured image; wherein the obtained cooking state is based at least in part on the extracted feature vector.
